(19) United States
(12) Patent Application Publication
(10) Pub. No.: US 2007/0177615 A1
(43) Pub. Date: Aug. 2, 2007

(54) VOIP SECURITY

(76) Inventor: Gary S. Miliefsky, Tyngsboro, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/622,460

(22) Filed: Jan. 11, 2007

Related U.S. Application Data
(60) Provisional application No. 60/757,626, filed on Jan. 11, 2006.
(60) Provisional application No. 60/868,268.

(51) Int. Cl. H04L 12/56

(52) U.S. Cl. 370/401

(57) ABSTRACT

Disclosed herein are techniques for protecting VoIP networks by defending against malicious traffic and malicious access to the systems and networks used for the transmission, storage and management of VoIP data, including defense against weaknesses inherent in VoIP, Local Area Network (LAN), Wide Area Network (WAN) and Internet networks used to carry VoIP traffic.

### RELATED APPLICATIONS

This application claims the benefit of U.S. App. No. 60/757,626 filed on Jan. 11, 2006, the entire content of which is incorporated herein by reference.

This application is also related to the following commonly-owned U.S. Patent applications, each of which is incorporated herein in its entirety: U.S. application Ser. No. 11/338,870 filed on Jan. 23, 2006, U.S. application Ser. No. 10/898,900 filed on Jul. 26, 2004, U.S. App. No. 60/489,982 filed on Jul. 25, 2003, U.S. App. No. 60/646,336 filed on Jan. 21, 2005, U.S. App. No. 60/754,570 filed on Dec. 27, 2005, and U.S. App. No. 60/868,268 filed on Dec. 1, 2006.

### BACKGROUND

1. Field of the Invention

The present invention relates generally to network security systems and more particularly to vulnerability management and intrusion prevention systems for Voice over Internet Protocol (VOIP) networks.

2. Related Art

Numerous information security risks are inherent in VoIP Networks and can be broadly categorized into the following three types: Confidentiality, Integrity and Availability. Packet networks depend for their successful operation on a large number of configurable parameters: IP and MAC (physical) addresses of voice terminals, addresses of routers and firewalls, and VoIP specific software such as call managers and other programs used to place and route calls. Many of these network parameters are established dynamically every time a network component is restarted, or when a VoIP telephone is restarted or added to the network. Because there are so many places in a network with dynamically configurable parameters, intruders have a wide array of potentially vulnerable points to attack.

Confidentiality refers to the need to keep information secure and private. For home computer users, this category includes confidential memoranda, financial information, and security information such as passwords. In a telecommunications switch, the risk of intruders eavesdropping on conversations is an obvious concern, but the confidentiality of other information on the switch must be protected to defend against toll fraud, voice and data interception, and denial of service attacks. Network IP addresses, operating system type, telephone extension to IP address mappings, and communication protocols are all examples of information that, while not critical as individual pieces of data, can make an attacker's job easier. With conventional telephone systems, eavesdropping usually requires either physical access to tap a line or penetration of a switch. Attempting physical access increases the intruder's risk of being discovered, and conventional PBXs have fewer points of access than VoIP systems. With VoIP, opportunities for eavesdroppers increase dramatically, because of the many nodes in a packet network.

Integrity of information means that information remains unaltered by unauthorized users. For example, most users want to ensure that bank account numbers cannot be changed by anyone else, or that passwords are changed only by the user or an authorized security administrator. Telecommunication switches must protect the integrity of their system data and configuration. The richness of feature sets available on switches provides an attacker with plenty of tools. A hacker who can compromise the system configuration has opened the door to a variety of potential hacks. For example, a hacker could reassign an ordinary extension into a pool of phones that the hacker can then eavesdrop on the same way that supervisors can legitimately listen in on or record conversations for quality control purposes. Another action the intruder can take is to damage or delete information about the IP network used by a VoIP switch, producing an immediate denial of service. The security system itself provides capabilities for system abuse and misuse. Compromise of the security system not only allows system abuse but also allows the abuser to eliminate all traceability (covering his tracks) and insert trapdoors for future intruders to use on their next visit. For this reason, the security system must be carefully protected. Integrity threats include techniques that can result in system functions or data being corrupted, either accidentally or as a result of malicious actions. Misuse is not restricted to outsiders, and may often involve legitimate users (insiders performing unauthorized operations) as well as outside intruders. A legitimate user may perform an operations function incorrectly, or take unauthorized action, resulting in deleterious modification, destruction, deletion, or disclosure of switch software and data. This threat may be opened up by several factors, including the possibility that the level of access permission granted to the user is higher than what the user needs to remain functional.

Availability refers to the notion that information and services will be available for use when needed. Availability is the most obvious risk for a switch. Attacks exploiting vulnerabilities in the switch software or protocols may lead to deterioration in service or even denial of service or denial of some functionality of the switch. For example: if unauthorized access can be established to any branch of the communication channel (such as a CCS link or a TCP/IP link), it may be possible to flood the link with bogus messages, causing severe deterioration (possibly denial) of service. A voice over IP system may have even more vulnerabilities when it is connected to the Internet. Because intrusion detection systems (IDS) fail to intercept a significant percentage of Internet based attacks, once attackers circumvent the IDS, they may be able to bring down VoIP systems by exploiting weaknesses in Internet protocols and services. Any network can be made vulnerable to denial of service attacks simply by overloading the capacity of the system. With VoIP the problem may be especially severe, because of its sensitivity to packet loss or delay. An attacker with remote terminal access to the server may be able to force a system restart (shutdown all/restart all) by providing the maximum number of characters for the login and password buffers multiple times in succession. Additionally, IP Phones may reboot as a result of this attack. In addition to producing a system outage, the restart may not restore uncommitted changes or, in some cases, may restore default passwords, introducing the possibility of intrusion vulnerabilities. The deployment of a firewall disallowing connections from unnecessary or unknown network entities is the first step to overcoming this problem. However, there is still the opportunity for an attacker to spoof his MAC and IP address, circumventing the firewall protection.

It can be appreciated that vulnerability management and intrusion prevention systems have been in use for years. Typically, vulnerability management and intrusion prevention systems are comprised of software for vulnerability management and intrusion prevention as well as hardware and turnkey network security auditing appliances and application service provider (ASP) solutions. They are designed to improve security in traditional computer-related networks including but not limited to local area networks (LANs), wide area networks (WANs) and Internet connected systems.

The main problem with conventional vulnerability management and intrusion prevention systems are that although they find common vulnerabilities and exposures in computer networks and/or malicious traffic sent over local area networks (LANs), Extranets and the Internet, they are not designed to automatically audit and secure Voice over Internet Protocol (VOIP) networks and the related confidential communications that take place in these networks.

Another problem with conventional vulnerability management and intrusion prevention systems are that although they may be sold to medium size and large enterprises, they are too complex, expensive, cumbersome and difficult to deploy in small to medium size enterprises as well as branch offices of larger, geographically disperse organizations. Most are designed to take up the industry standard 1U rack mount size and cost tens of thousands of dollars to install, deploy and manage, yet they cannot guarantee security for VoIP networks.

Another problem with conventional vulnerability management and intrusion prevention systems is their inability to be deployed on tiny, micro devices. In the same fashion that the firewall market has scaled down their appliances to fit on the desktop and store their data on small FLASH or COMPACT FLASH or FLASH ROM or FLASH RAM or MICRO DRIVES, this market needs a tiny, cost effective solution that is easily deployed and managed to help secure smaller organizations and/or branch offices against VoIP attacks.

Organizations of all sizes invest countless hours and billions of dollars each year on network security technologies. Yet they still continue to fall prey to denial of service attacks, viruses and blended threats, hackers and worms because the real network security culprits are Common Vulnerabilities and Exposures (CVEs). CVEs, anything that can be exploited on any computer, are the systemic cause of over 95% of all network security breaches. The creation of turnkey, easy to deploy VoIP security appliances will give small to medium size businesses (SMBs) and geographically disperse organizations with branch offices a solution that is affordable, providing access to proactive network security to harden their VoIP networks, including simplified CVE Vulnerability Management as well as clientless Network Admission Control (NAC) through integration with INFOSEC countermeasures whether they are VoIP ready or traditional (this includes but is not limited to Firewalls, VPNs, IDS, IPS, Patch Management, Configuration Management and SmartSwitches). End users will be able to proactively defend their VoIP Networks and quarantine vulnerabilities without having to install a client on every device or spend thousands of dollars on complex systems.

While these devices may be suitable for the particular purpose to which they address, they are not as suitable for helping Information Technology (IT) Managers better see and remove the problems or flaws, also known as common vulnerabilities and exposures (CVEs), in their VoIP managed network equipment, computers, servers, hardware and related systems, which are used on a daily basis to store, edit, change, manage, control, backup and delete network-based assets. There remains a need for VoIP-oriented security systems to secure and monitor networks that support VoIP communications.

### SUMMARY OF THE INVENTION

Disclosed herein are techniques for protecting VoIP networks by defending against malicious traffic and malicious access to the systems and networks used for the transmission, storage and management of VoIP data, including defense against weaknesses inherent in VoIP, Local Area Network (LAN), Wide Area Network (WAN) and Internet networks used to carry VoIP traffic.

The VoIP Vulnerability Management and Intrusion Prevention Systems for Voice over IP (VoIP) networks described herein may be deployed through software and on industry standard rack mount as well as smaller micro appliances, and can be used to help Information Technology (IT) Managers better see and remove the problems or flaws, also known as common vulnerabilities and exposures (CVEs), in their VoIP managed network equipment, computers, servers, hardware and related systems, which are used on a daily basis to store, edit, change, manage, control, backup and delete network-based assets. The systems disclosed herein may include data replication, correlation and warehousing for reporting, trending, real-time vulnerability and gap analysis among multiple micro appliance deployments. This permits larger geographically distributed enterprises with many branches to have a “dashboard” view of their threat and risk profiles throughout their VoIP Networks.

In one aspect, the system disclosed herein may include one or more of the following components: a dashboard or graphical user interface (GUI), a security access control (AUTH) and secure communications subsystem (SEC-COMM), Transport Control Protocol/Internet Protocol (TCP/IP), User Datagram Protocol (UDP) and Session Initiation Protocol (SIP) network and asset discover and mapping system (T-U-S-NAADAMS), a VoIP asset management engine (VAME), VoIP vulnerability assessment engine (VOIP-CVEDISCOVERY), vulnerability remediation and workflow engine (VoIP-CVE-REMEDY), a reporting system (REPORTS), a subscription, updates and licensing system (SULS), a VoIP ready countermeasure communications system (VOIP-COUNTERMEASURE-COMM), a logging system (LOGS), a database integration engine (DBIE), a database correlation and warehousing engine (DCAWE), a scheduling and configuration engine (SCHEDCONFIG), a VoIP device, wireless-enabled and mobile devices/asset detection and management engine (VoIP-WIRELESS-MOBILE), a notification engine (NOTIFY), a regulatory compliance reviewing and reporting system (REG-COMPLY), clientless VoIP network admission control (VOIP-CLIENTLESS NAC) integration with all major INFOSEC Countermeasures (including but not limited to firewalls, VPNs, ids, ips, patch management, configuration management and SmartSwitches) to dynamically reconfigure the firewall and SmartSwitch rules and access tables to quarantine problems (CVEs) at the network ports, whether physical or based on the internet standard (TCP/IP), UDP, SIP or otherwise for ports, or similar protocol based software ports, where these problems reside.

In one aspect, a method for securing a VoIP system disclosed herein includes auditing a network containing a plurality of assets to identify one or more of the plurality of assets associated with a VoIP system; and identifying one or more vulnerabilities associated with the one or more of the plurality of assets.

Identifying one or more vulnerabilities may include comparing a dictionary of common vulnerabilities and exploits to the one or more of the plurality of assets. The method may include monitoring the network to detect changes in the one or more of the plurality of assets associated with the VoIP system and, in response to a detected change, identifying any additional vulnerabilities. The detected change may include an addition of a VoIP phone. The method may include reconfiguring the network to secure the network against the additional vulnerabilities associated with the VoIP phone. Identifying one or more vulnerabilities may include periodically updating a dictionary of common vulnerabilities and exploits. The method may include reconfiguring the network to secure the one or more of the plurality of assets against the one or more vulnerabilities. Reconfiguring the network may include securing an existing hole in a VoIP phone. Reconfiguring the network may include securing an existing hole in a VoIP gateway. Reconfiguring the network may include securing an existing hole in a VoIP firewall.

In another aspect, a method for securing a VoIP system described herein may include auditing a network to identify a plurality of network assets; identifying one or more vulnerabilities associated with a VoIP resource connected to the network; and reconfiguring the network to secure the network against the one or more vulnerabilities.

The method may include adding the VoIP resource to the network. The VoIP resource may include includes an administrative interface to a VoIP network. The VoIP resource may include a VoIP phone. The VoIP resource may include a VoIP gateway.

In another aspect, a method of securing a VoIP system may include auditing a network to identify one or more assets associated with a VoIP system;

monitoring the one or more assets of the VoIP system to identify VoIP traffic; and analyzing the VoIP traffic for the presence of a security threat.

The method may include creating an alert when a security threat is detected. The method may include terminating a VoIP connection when a security threat is detected. Analyzing the VoIP traffic may include identifying at least one of a malformed VoIP packet, an unexpected traffic pattern, and an unexpected VoIP session. Analyzing the VoIP traffic may include at least one of intrusion detection, network sniffing, exploit signature detection, and heuristic monitoring. The method may include enforcing at least one Quality of Service constraint on VoIP traffic.

It will also be understood that, where methods are described above, the scope of this disclosure includes computer executable code and various systems having the features described, and similarly where systems are described, the scope of this disclosure includes various methods for operating those systems. All such variations are intended to fall within the scope of this disclosure.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts a system architecture for VoIP security.

FIG. 2 depicts an overview of an architecture for a security appliance 200 to support VoIP security.

FIG. 3 is a perspective drawing of a VoIP security appliance.

FIG. 4 shows a user interface for an appliance described herein.

FIG. 5 illustrates management of a distributed VoIP network.

FIG. 6 shows various devices in a VoIP network.

FIG. 7 depicts a generalized relationship of a user interface for an appliance to the various software components described above.

FIG. 8 depicts a relationship between a subscription engine client and a subscription engine server.

FIG. 9 is a flow chart showing operation of a VoIP security appliance.

### DETAILED DESCRIPTION

The systems described herein include various techniques for securing VoIP networks and providing tools for auditing, monitoring, and fixing security threats within a VoIP network. It will be understood that a variety of standards exist for signaling, routing, and encryption of voice communications over data networks including open standardized protocols (e.g., Session Initiation Protocol, H.323, etc.) and proprietary standards used by various VoIP vendors. In addition VoIP is commonly referred to by a variety of names including IP Telephony, Internet telephony, Broadband telephony, Broadband Phone and Voice over Broadband. As used herein, Voice over IP and VoIP are used generally to refer to all such systems for creating and maintaining voice conversations on IP or other data networks, and all such variations as would be understood by one of ordinary skill in the art are intended to fall within the scope of this disclosure.

It will further be understood that a number of vulnerabilities exist for VoIP networks and network assets that are distinguishable from vulnerabilities for conventional networks and network assets. For example, a VoIP system is vulnerable to post hoc eavesdropping by replaying Internet traffic. The SIP protocol, which supports most VoIP systems, has its own known vulnerabilities and security issues, as does H.323 (also used for voice communications over data networks. Similarly, a data network can be impaired by a VoIP-based denial of service attack, and conversely, a VoIP network can be vulnerable to data network denial of service attacks. At the same time, particular VoIP assets, such as a dedicated VoIP phone from a particular vendor, may have its own vulnerabilities, which may be based on the particular hardware/software implementation used to deploy the phone, or on known vulnerabilities in a component of the phone (such as the operating system, software, hardware, chipsets, or some combination of these). While numerous specific examples may be identified, for the general purposes of the following disclosure, it should suffice to note that VoIP networks and VoIP network assets present different security risks and vulnerabilities than conventional data network assets.

It should also be noted that a number of types of VoIP assets are contemplated by the following description. A dedicated VoIP device, such as VoIP phone hardware or a VoIP server, is exclusively or primarily dedicated to VoIP functions. These devices, e.g., a VoIP phone using unsecured open source software or a VoIP gateway that includes a port connected to a Public Switched Telephone Network or other voice network, may have their own vulnerabilities. Such devices must be identified and dealt with on a device-by-device basis. Other devices may be general purpose devices that include one or more VoIP functions. For example, a laptop computer may be configured to operate as a VoIP terminal. In such cases, the device may include VoIP-specific vulnerabilities, as well as conventional data network vulnerabilities that can be used to access and exploit the VoIP interface. In general, a VoIP asset may include either or both of these devices—a dedicated VoIP device or a general purpose device with VoIP functionality—unless a more specific meaning is otherwise provided or clear from the context.

Systems supporting the VoIP security techniques disclosed herein may include data replication, correlation and warehousing for reporting, trending, real-time vulnerability and gap analysis among multiple appliances of various shapes and sizes from high-end blade deployments, to 1 u rack mount devices to micro appliance deployments. This also includes administrative and user interfaces such as a dashboard view of threat and risk profiles for an entity throughout intranets, local area networks, wide area networks, virtual private networks, Extranets, and so forth. Thus while various configurations of hardware, software, and network infrastructure are described, the systems and methods described herein may more generally be applied to any system including or supporting VoIP communications.

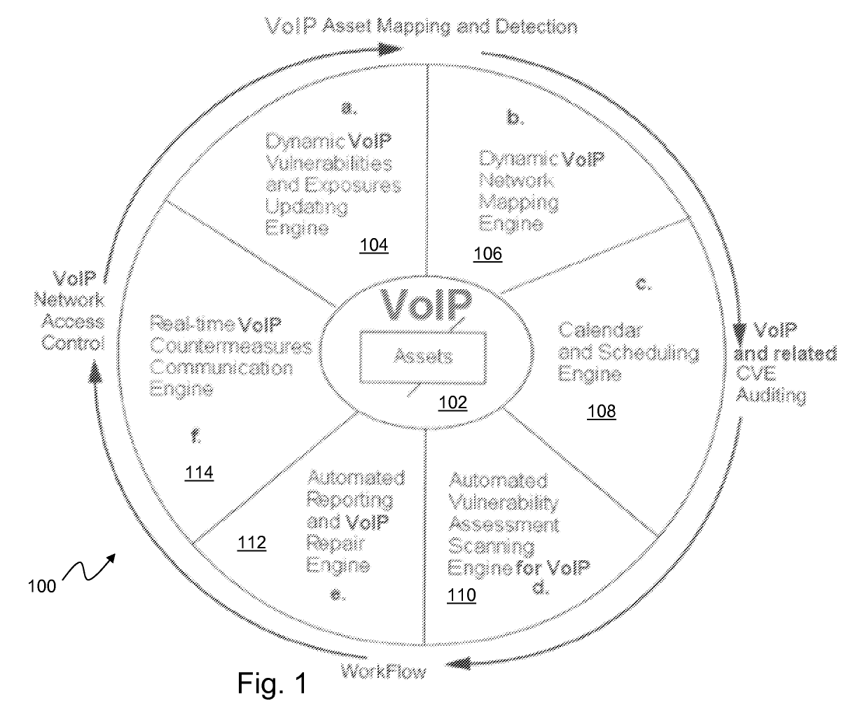

FIG. 1 depicts a system architecture for VoIP security. In general the components of the system cooperate to provide VoIP vulnerability management, intrusion prevention, and clientless VoIP network admission control. The system 100 may includes a plurality of network assets 102 supporting VoIP communications, a vulnerabilities update engine 104, a network mapping engine 106, a scheduling engine 108, an assessment engine 110, a reporting engine 112, and a countermeasures engine 114.

The assets 102 may include any assets used in a VoIP network infrastructure including without limitation firewalls, routers, gateways, VoIP phones, switches, relays, SmartSwitches, hubs, and any of the other network components noted in the following description, as well as various hardware and software interfaces to any of the foregoing.

The vulnerabilities update engine 104 may detect trusted and untrusted VoIP and related network assets, block and alert untrusted hosts or audit and block ports on trusted hosts with VoIP and related CVEs. The network mapping engine 106 may map the local area network for trusted and untrusted VoIP asset SIP location, IP Addresses with MAC Address and Operating System (OS) information. The scheduling engine 108 may manage scheduled auditing and other procedures. The assessment engine 110 may perform vulnerability scans for CVEs in each asset 102. The reporting engine 112 may then generate one or more reports and initiate a workflow process for the repair (manual or automatic) of the CVEs, which have been discovered. The countermeasures engine 114 may support clientless network access control by driving VoIP ready firewalls, VPNs and SmartSwitches to be automatically reconfigured through remote control using their published application programming interfaces (APIs). The countermeasures engine may communicate with these resources through secure means such as OPSEC or authenticated SSH and command line interfaces.

As depicted in FIG. 1, the various aspects of the system may operate in a security cycle that continuously, periodically, or on some other schedule or interval, detects, reports, and fixes security threats within a network of VoIP assets.

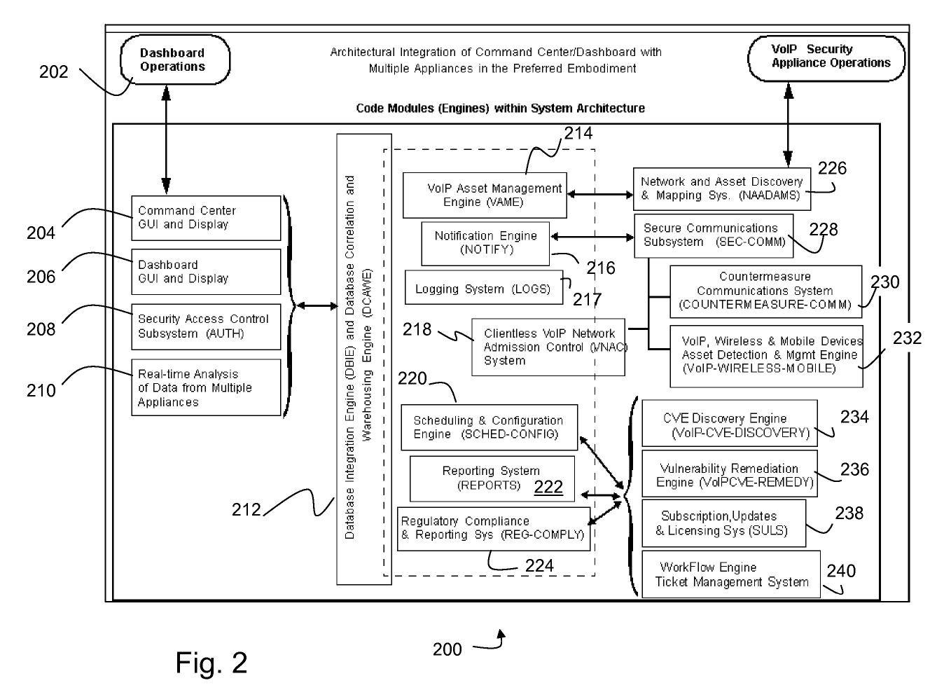

FIG. 2 depicts an overview of an architecture for a security appliance 200 to support VoIP security. In general, the system may be designed around a number of engines which work together to provide state of the art vulnerability assessment, malicious traffic inspection, reporting, management, and remediation capabilities on a micro-platform. Other than a one time setup interface over a serial connection to a hyperterminal interface, the appliance may operate as a headless device where the end-user interface is through a secure web interface. Data may be stored in both a flat-file format and a secure relational database server. The vulnerability assessment component may be based on an intelligent scan engine which scans network assets for flaws and weaknesses in the systems. A network discovery engine may provide a means to determine the assets on a network both through on-demand means initiated by an end-user and through dynamic detection as assets appear on the network. Vulnerability and asset data is stored in the appliance and reporting results may be automatically generated and provided on demand through a query interface. Vulnerable systems may be quarantined from the network through a countermeasure engine which interacts with firewalls, SmartSwitches and other similar devices. All vulnerability data may be passed to a workflow engine which allows the end-user to assign remediation needs to resources, track the status and escalate the status as needed. A notification engine may be tied in to all processes providing the end-user instant information on the status of the network and the components in the appliance. A dashboard and command center may allow a user an easy interface to manage and review the status of the entire network and assets whether they are local or in remote locations. A logging engine may collect all pertinent data about the system, user access, functionality and processes on the appliance. These general components are described in greater detail below.

Various dashboard operations 202 such as viewing reports, administering a network, receiving alerts, and so forth, may be undertaken through a variety of user interfaces. The appliance 200 may support this user interface through, for example, a command center GUI and display 204, a dashboard GUI and display 206, a security access control subsystem 208, and a real-time analysis interface 210.

The user interfaces may include a secure graphical user interface which provides an interface for a user to configure the VoIP security system for a particular network environment, manage the assets of the network, create configurations to audit the assets in the network, access and view reports on the vulnerabilities of the network, and so forth. The interfaces may also, or instead, include an interface for a subscription service that provides vendor updates for the VoIP security system including up sells to existing products, downloads of compliance documents, updates to CVE data, and so forth. The interface may also include a dashboard where a user can track the changes in the network, see logging information of the activity on the appliance and more generally any compiled information which can be obtained from the knowledge gathered about the assets in the network.

The security access control subsystem 208 may provide a secure method in which an end-user can access a security appliance and all the functionality of that appliance as well as providing secure means in which to upload and download files, reports, subscription data and in general any relevant data compiled, generated or related to the functionality of the appliance. The secure communications subsystem 208 may use the secure internet protocol of secure sockets layer (SSL) or the secure hypertext transfer protocol (HTTPS) to share information between the GUI client and appliance 200.

In one aspect, the user interfaces may operate on a web server model, which may be secured for example through Secure Sockets Layer (SSL/HTTPS) or presented non-securely (HTTP) over the Internet or local area network (LAN). Each screen may be dynamically generated as a result of web-based (HTML) input from an end user and the current state of the network. In another aspect, the user interface components may be deployed as a client-based application, developed using standard Windows or similar GUI client tools that can connect either securely or insecurely over a network to a server-side interface using a secure communications subsystem. Other methods include the development of a GUI using the JAVA programming language or MYSQL databases with Perl, Python or PHP tied into a small web application server. For example, the interface components may communicate with other aspects of the appliance 200 and a network through a database integration engine 212 which may provide various database functions include access control, analysis, and warehousing.

Graphical user interface that displays reports and real time analysis from data gathered by multiple VoIP Security Software and Appliances: This engine provides a means to gather data in a multi-branch environment from numerous VoIP Security devices; correlate this data; and display data, trends, status and real time analysis of this data. It provides a means to query from an updated data warehouse to provide user defined reports and information. It also provides a means to remotely manage the VoIP Security devices. This engine provides a network summary including but not limited to missing network devices, vulnerability counts, interactions with countermeasures and status of the vulnerability tests, and code and subscription updates across the multi-branch environment.

The graphical user interface (GUI), which may employ the user interface components described above, may provide connections to all components of the appliance. It is the means in which the end-user has access to control the functionality of the appliance. This may include, obtaining various reports provided by the system, viewing results of asset discovery in human-readable form, viewing or changing various parameters that govern operation of the appliance 200 (e.g., scheduling, report intervals, remediation techniques, external sources for CVE data, notification protocols, and so forth), and the like. In general, each of the components described below may be accessed and controlled directly or indirectly through the graphical user interface for the appliance 200.

The database integration engine 212 may gather data from various processes and results throughout the appliance as well as from internal/external resources, including but not limited to the update servers, countermeasure appliances, data feeds, and any other devices or resources either within the VoIP network (or data network supporting same), or externally (such as where a third party maintains a periodically updated dictionary of common vulnerabilities and exploits). The engine 212 may use data warehouse methodologies to store this data. The engine may also provide a means of querying the database and warehouse information either through automated methods or through on-demand user interfaces.

The VoIP asset management engine 214 may cooperate with the network and asset discovery mapping system 226 to track the changes in the VoIP assets and other related assets on the network, and to provide data for an overview of the network (as well as detailed information, where appropriate) to a system administrator. The engine 214 may compile statistics for these assets providing information to the user to better manage those assets and support compliance with government regulations and the like. The engine 214 may communicate with other aspects of the appliance 200 and a network connected thereto to create and manage a list of all assets within the network including IP Address, MAC address and Operating System. The engine 214 may provide ADD, DELETE, EDIT and RENAME functionality for each discovered network asset.

The notification engine 216 may interacts with all components of the appliance 200 illustrated in FIG. 2 to provide notifications, alerts and status based on network activity. Notification may be provided from the engine 216 through email, SMS messages, cell phone alerts, pager messages and any other suitable communication system to reach appropriate automated systems or personnel. The notifications may be customized to provide user-selected notification protocols according to the needs of a particular entity or management group that installs the appliance 200.

The logging system 217 may provide an end-user with data of the activities on the VoIP security appliance. This includes system, user and event logs. The system logs comprise, but are not limited to, issues related to the hardware, software, services and network, and any changes that may occur to these components, whether through user interaction, automated functionality, system failure or any other means. The user logs comprise, but are not limited to, activities instigated by an end-user. This includes any access to the appliance and subsequent activity performed by that user. User logging will also include tracking of concurrent users accessing the product, when any access occurred, failed login attempts and any unauthorized activity. Event logging includes any operating system related issues, reboots, shutdowns, as well as update activities including the vulnerability test updates, code updates, subscription service updates, license upgrades and related activities.

The clientless VoIP network admission control system 218 may provide a means to control the access of VoIP and related network devices onto networks. The engine 218 may operate without requiring any software to be installed on any of the target devices. The engine 218 may use, for example, a combination of the network discovery engine, vulnerability assessment engine, database correlation engine, wireless and mobile device detection engine to determine when a network device has permission to access the network. This determination may also be based upon information obtained from the regulatory compliance reviewing and reporting system and policies. This engine 218 may interact with the countermeasure communications system to control the access of each network appliance. The engine 218 may be designed to work in a multi-branch solution and provide extensible authorization. It may securely connect to VoIP ready and industry standard firewalls, SmartSwitches, IDS, IPS and VPNs to reconfigure their rules and access control lists around VoIP and related CVE related problems and ports.

The scheduling and configuration engine 220 may control any process on the appliance that pertains to scheduled activities or the configuration of the system, audits or any processes running on the product. This includes but is not limited to the auto-update process for obtaining vulnerability tests, subscription updates or code updates. It may also include auditing and reporting processes, workflow, network discovery, dashboard, command center, and logging processes of the VoIP security appliance.

The reporting system 222 may generate reports in various formats providing information to the user about vulnerabilities on a network/system, methods of remediating these vulnerabilities, assets on a network, updates to the system, compliance with regulations as well as any pertinent information about the state of their network. Reporting system 222 variations may include centralized reporting for a plurality of appliances, easily customizable reports for flexible reporting, automated trending and differential reports for gap analysis, remediation reporting for the workflow engine including ticket trending and tickets by group, user, and vulnerability as well as web-based reporting immediately available to authorized users. Reports may be output in PDF, XML, CSV, XLS, HTML, and other industry standard report formats.

The regulatory compliance and reporting system 224 may combine rules and reporting of a variety of different types. For example, compliance and reporting may be determined with reference to one or more of a corporate security policy, government regulations, business security programs, and so forth. Reporting may address, e.g., vulnerability assessment, malicious traffic and any other suitable subject matter for assessing and reporting the status of assets as they pertain to regulatory compliance. The system 224 may tie regulations, company policies and security programs to assets and to vulnerability tests in order to ascertain the level of compliance with these regulations, policies and programs. This engine 224 may use data obtained through the vulnerability assessment engine to assess the level of compliance. Automated actions may be triggered by these results in conjunction with the countermeasure engine to ensure the security of assets as well as compliance with policies and regulations. The engine may also provide related data to the alerting engine, the reporting and database correlation and warehouse engines.

The network and asset discovery/mapping system 226 may provide a network and asset discovery mapping system that will determine VoIP and other assets that are on the network both through an on demand asset detection engine as well as a dynamic detection engine. It may gather data about these assets including the system information, application information, user information, location and other relevant information. The system 226 may use various methodologies to poll devices throughout the local area network (LAN) to determine what systems are available and online. Each network asset will typically respond with an IP Address and through standard packet sniffing methodologies, the system 226 may determine the MAC address and Operating System of detected assets, as well as any other available information.

The secure communications subsystem 228 may support any of a variety of secure connections with network assets, either through secure communications protocols, authentication and login, or the like, as well as various combinations of these.

The countermeasure communication system 230 may share dynamically detected information about current and new VoIP network assets for the dynamic reconfiguration of VoIP ready firewalls, virtual private networks (VPNs) and SmartSwitches to quarantine VoIP and related CVEs (problems) detected in any and all trusted VoIP network assets at the port level, blocking problems at ports, and the like. In the event a VoIP network asset is untrusted, such as a rogue VoIP enabled wireless device, laptop or wireless router, the detected device may be quarantined at all possible points of entry and exit including but not limited to the firewall, VPN, ids, ips and SmartSwitch. The system 230 may also send an alert through E-mail and SMS paging to an IT Manager or designated end user to let them know that the system detected a rogue or high risk asset and took action, automatically.

The asset detection and management engine 232 may detect, e.g., VoIP enabled device, Wireless and other VoIP and related mobile devices, and other network assets. The engine 232 may include a VoIP, wireless access point and mobile device discovery system which link into the notification engine, countermeasure engine and database engine. The discovery engine 232 may detect assets through various means including network scanners such as Nmap, Nessus, SARA, DHCP broadcasts, traffic analyzers and SNMP traps and other similar tools. The engine 232 may send alerts through the alerting engine relating data about the existence and state of wireless and mobile devices discovered. The engine may also interact with the countermeasure engine, providing a means to quarantine and/or control the flow of traffic to and from the wireless and mobile devices. This includes traffic control via firewalls, SmartSwitches, VPNs and similar technology. The engine may also interact with the database engine to store and track all data related to wireless and mobile assets.

The CVE discovery engine 234 may audit all of the VoIP and related devices on a network to determine the vulnerabilities it has which hackers, viruses or worms could exploit. This engine 232 may use several levels of intrusiveness severity to control how rapidly it detects the vulnerabilities as well as how sever a particular detection is. The engine 232 may also retain a database of past audits allowing for differential audits comparing previous audits with current audits as well as incremental audits which test for only the latest known vulnerabilities. The engine may use a similar approach to CVE discovery as the Open Source Nessus.org project and the Open Source SARA project, or any other suitable techniques for timely discovery of security threats within a VoIP network. This includes detection of flaws, missing patches, and so forth, and may be network, device, or operating system specific.

The vulnerability remediation engine 236 may allow for both automated and on-demand methods of remediating VoIP and related security vulnerabilities that have been found on VoIP and related assets in the network. This may include scripts, macros and other similar methods used to remove vulnerabilities from the network. VoIP Common vulnerabilities and remediation engine 236 variations may include functionality to allow customers to select which IP Addresses need to be repaired by the removal of the Common Vulnerability and Exposure (CVE) which has been discovered. The workflow engine 240 may enable end users to accept CVE repairs and if a client or agent exists on the network asset that contains a VoIP or other related CVE, a connection may be made to the client to initiate a patch or system reconfiguration and resolve the VoIP and related CVE.

The subscription system 238 may provide the end-user a method of obtaining the latest vulnerability tests, code updates and in general any subscription updates they have paid for. This system provides a licensing system so that these updates can be properly managed by one or more providers of security-related subscription services. The system 238 may be composed of a server engine (not shown) on a publicly hosted site and a client-engine on each appliance. The server engine may contain a database, a license manager and all vulnerability tests, code updates and subscription data and files pertinent to the subscription service. The client engine may contain a secure mechanism to request updates from the server as well as a mechanism to change the license available to the end-user. The engine 238 may include built-in functionality to connect to the subscription server and obtain various pieces of information including subscription start date confirmation, subscription end date confirmation, options to expand current subscriptions and an e-commerce component to enable instant one-click purchasing of subscription updates. The engine 238 may also allows end customers to obtain soft updates for any functionality that has been improved or changed in the system and help ensure currency through timely updates of the VoIP Vulnerability Management and Intrusion Prevention system.

The workflow engine 240 may include a workflow control system, ticketing control system, tracking and verification system which integrate reporting, asset, workflow and logging databases of the VoIP security appliance 200. The engine 240 may use data warehouse methodologies to correlate data from numerous sources via a command center. The workflow control system may set up, distribute and manage the overall security workflow process within the appliance 200. The ticketing control system may assign workflow activities to customer defined resources, assign priorities and escalate priorities as needed. The tracking and verification portion of the engine 240 may keep a status of the workflow process, provide reports and alerts, and finalize completed workflow activities. The workflow engine may employ suitable drivers for database integration such as ODBC (Open DataBase Connectivity), JDBC (Java Database Connectivity), UDBC (Universal Database Connection) and OLE DB & CROSS to fully integrate the underlying databases with the applications running on the system.

A variety of hardware implementations of the appliance 200 are possible. The appliance 200 may, for example, be deployed on a personal computer, server, rack-mounted server, micro-appliance or other dedicated or general purpose device. One possible micro-appliance hardware configuration for the VoIP security appliance is now described in greater detail.

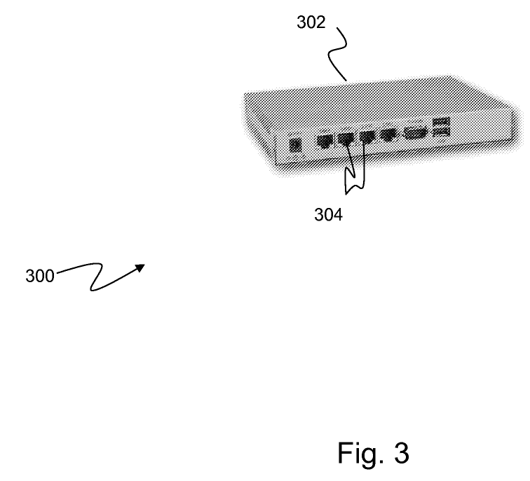

FIG. 3 is a perspective drawing of a VoIP security appliance. In general, the appliance 300 may include a chassis 302, a variety of physical ports 304, indicators (not shown) and a display (not shown).

Inside the chassis 302, the appliance 300 may house various components of system hardware such as: a central processing unit such as an Intel Pentium 4 or Celeron that supports hyperthreading, 4 GB of DDR2 SDRAM, an Intel E7221 chipset, 2 Broadcom BCM5721 Gigabit Ethernet controllers, an integrated ATI Rage XL video controller, a 260 Watt power supply, thermal control, a cooling fan, and internal ports such as one or more PCI slots, internal drive bays, and the like. The physical ports 304 may include, for example, 2 EIDE ports, 2 SATA ports, power, USB ports, LAN ports (e.g., RJ-45), a mouse port, a keyboard port, one or more parallel ports, one or more serial ports, or any other suitable device, peripheral, or network ports. In one embodiment, the chassis 302 may be shaped and sized as a mini (1U) fourteen inch rack-mountable IDE/SATA chassis. In addition, the chassis 302 may include a power on/off control, a system reset button, a power indicated (LED), a hard drive activity indicator (e.g., LED), one or more network activity LEDs, an overheat LED, and so forth. The system may operate on a Windows XP, Windows 2000, Windows NT, Windows Server 2003, Red Hat Linux, FreeBSD, SCO Unix, Sun Solaris, Novell or other operating system.

It will be understood that, while the system described above includes many possible physical embodiments of the appliance 200 described herein, numerous other variations of chassis configuration and hardware are possible. Any such combination of hardware and software may be suitably employed with the appliance 200 described herein provided the configuration can provide adequate network connectivity and computing resources to provide the services and functions described herein.

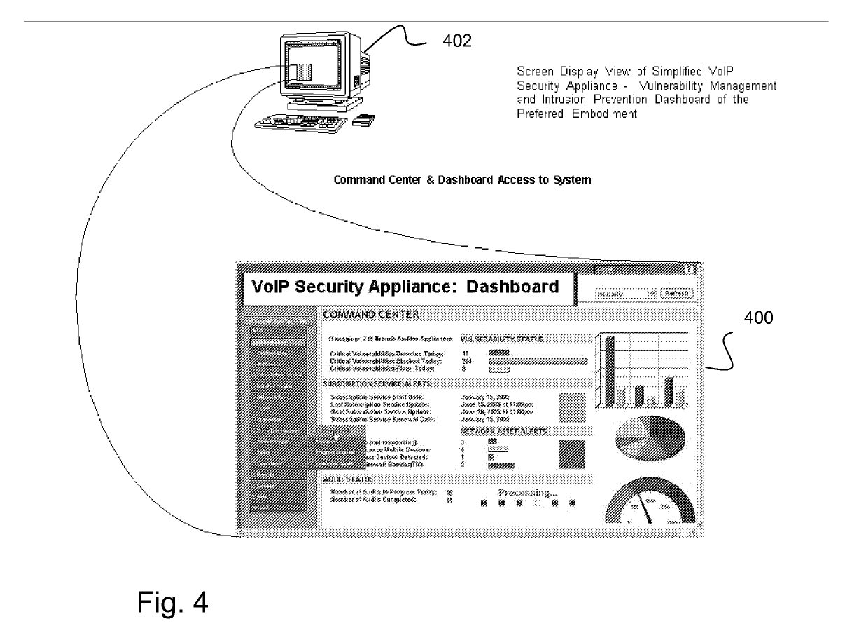

FIG. 4 shows a user interface for the appliance 200 described herein. The user interface 400, which may employ any of the interface elements or components described above, may provide system status information to a user, and may provide tools for a user to manage and control a secure VoIP network. The user interface 400 may be presented on a screen of a computer 402, which may, for example be a computer 402 that houses the appliance 300 described above, or may be a remote computer accessing the appliance 300 through web server or other techniques as generally discussed above.

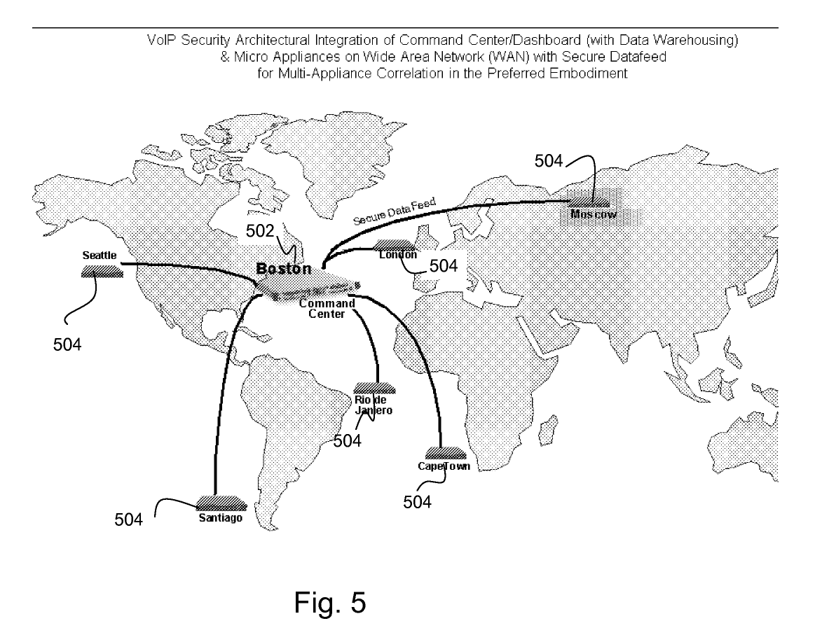

FIG. 5 illustrates management of a distributed VoIP network. As depicted, a command center 502 at a specific location (e.g., Boston, Mass., as depicted) may be employed to manage a number of remote appliances 504 which may be geographically distributed across any number of physical locations provided suitable communications connections can be formed among the appliances 504 and the command center 502. For example, as illustrated, appliances 504 may be located in Seattle, Washington (U.S.), Santiago, Chile; Cape Town, South Africa; London, Great Britain; Moscow, Russia; and so forth. Of course, it will also be understood that a single appliance 504 may be employed for a suitable small network of assets, and that similarly, a number of appliances 504 may be suitable employed at a single physical location (e.g., world headquarters of a large corporation) where a large number of VoIP and/or other network assets, or a high volume of VoIP traffic are present.

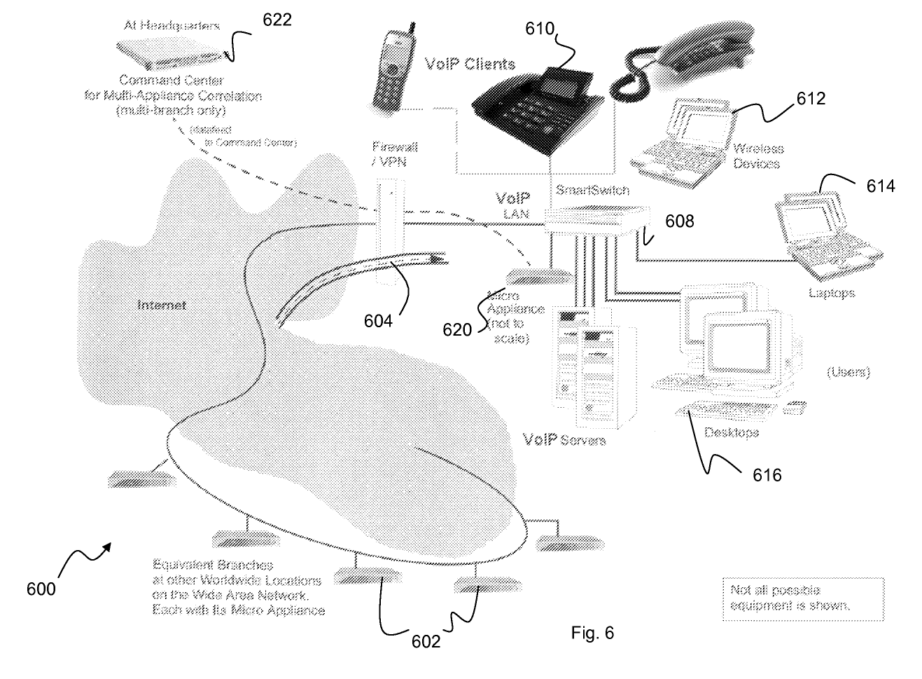

FIG. 6 shows various devices in a VoIP network. The VoIP network 600 may include, for example, a plurality of branches 602 of a corporate network, a firewall 604, a VoIP local area network 606, a SmartSwitch 608, one or more VoIP clients 610, one or more wireless devices 612, one or more laptops 614, one or more desktops 616, one or more VoIP servers 618, and at least one security appliance 620. Where a number of appliances 620 are present (such as at the plurality of branches 602), a command center 622 may also be included for coordinating the appliances.

In general, the appliance 620 may be any of the appliances described above. The VoIP clients 610 may include any VoIP capable device including a VoIP dedicated phone, a wireless VoIP phone, a laptop computer, desktop computer, and so forth. It will be understood that numerous assets may be present in a network that may either be VoIP devices, or not be VoIP devices, or optionally and or intermittently be VoIP devices. For example, desktop computers 614 or laptop computers 616 may periodically be employed to initiate or answer VoIP calls, and to operate as VoIP devices during the call. In general, the appliance 620 will detect and respond to these changes as appropriate, or select a configuration suitable for intermittent VoIP usage.

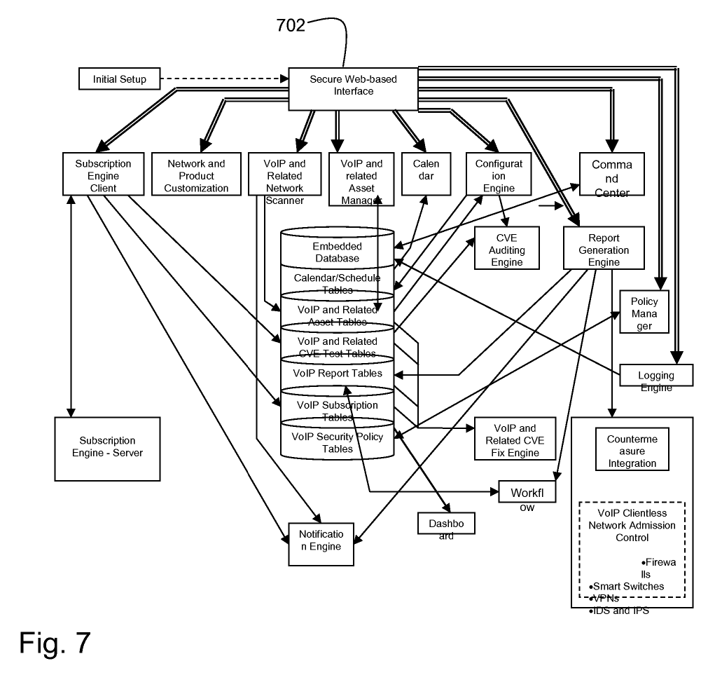

FIG. 7 depicts a generalized relationship of a user interface for an appliance to the various software components described above. As depicted, a secure user interface 702 may be operated to communicate directly and indirectly with the various components of the appliance software and databases described above. The user may also receive data from the various components, including status and identity information for various network assets detected by the appliance.

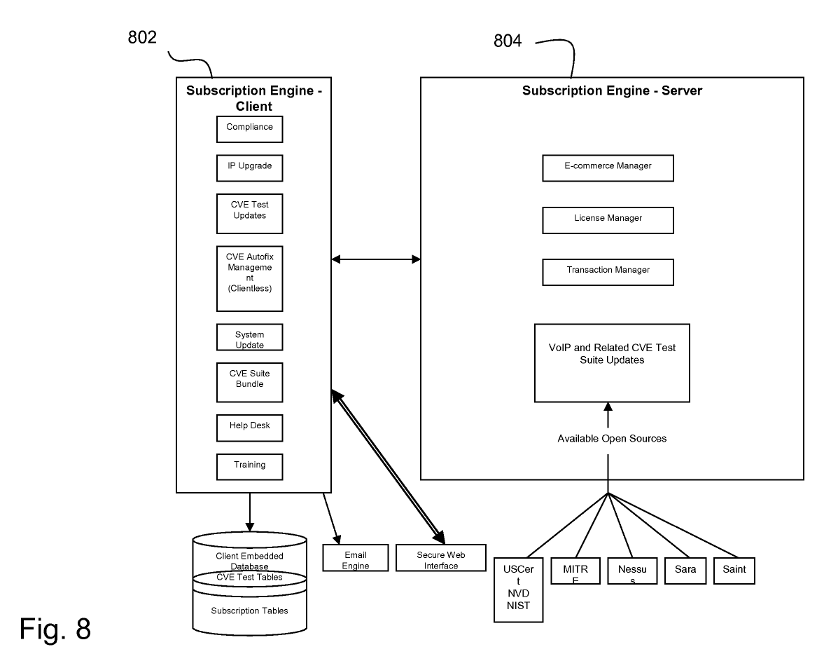

FIG. 8 depicts a relationship between a subscription engine client and a subscription engine server. In general, the client 802, which may operate as software within an appliance such as any of the VoIP security appliances described above, may communicate with a server 804 to periodically obtain security updates. The client 802 may maintain an embedded database of CVE test tables and the like to perform functions such as storing known vulnerabilities for testing against network and VoIP assets, and for storing results of CVE and other security tests. As noted generally above, the subscription engine may be controlled through a graphical user interface or other interface presented by the appliance to users.

The server 804 may be operated by a third party at a remote location accessible through, for example, the Internet or other data networks, and may provide fee-based based subscription services for periodic, continuous, or other updates to information such as common vulnerabilities and exploits. This may include, for example, direct subscriptions to security data provides (e.g., MITRE corporation for CVEs), or a subscription to a third party service that aggregates security data from a variety of commercial and/or non-commercial providers. Suitable providers of security data include USCert NVD NIST, MITRE, Nessus, Sara, and Saint. The server 804 may support licensing, transactions, and e-commerce suitable for controlling fee-based remote access to CVE (and other security-related) data.

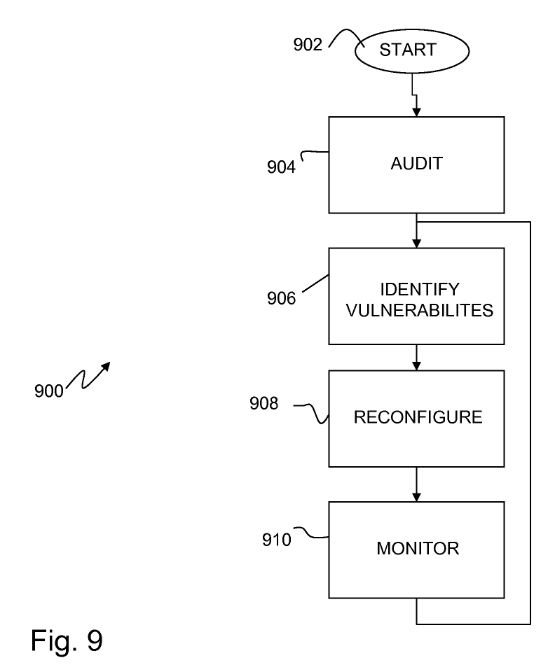

FIG. 9 is a flow chart illustrating operation of a VoIP security appliance described herein.

The process 900 may start 902 by performing an audit 904 of network assets. This process may be initiated by connecting an appliance, such as any of the appliances described above, to a network that is to be audited. The audit may result in an inventory of network assets such as any of those assets described above. In addition, VoIP-specific assets may be identified, such as VoIP clients (e.g., VoIP phones) and VoIP network elements (including both conventional network elements used to carry VoIP traffic, and VoIP specific elements such as VoIP firewalls, VoIP servers, and so forth. Audits are described in greater detail, for example, in U.S. application Ser. No. 10/898,900, incorporated herein by reference, and such auditing techniques may be adapted to VoIP security by including known vulnerabilities of VoIP devices in the dictionary of vulnerabilities supporting the appliance.

As shown in step 906, various vulnerabilities may be identified using, for example, reference to dictionaries or other compilations of known vulnerabilities and exploits, such as the CVE dictionary maintained by MITRE Corporation.

As shown in step 908, the network may be reconfigured to secure any holes in the network. This may include, for example, any combination of software patches, port blocking, filtering (e.g., MAC or IP filtering), and so forth appropriate for the vulnerabilities discovered during the audit. It will be appreciated that in general, the reconfiguration may be automated, manual, or some combination of these according to, e.g., the preferences of a network administrator, the size and intended use of the network under audit, and so forth.

As shown in step 910, the appliance may continue to monitor the network after reconfiguration. In addition to the general function of keeping the security posture of the network current, a continuous monitoring process may detect dynamic activity typical of VoIP systems, such as frequent addition or removal of VoIP clients from the network, or the initiation of or acceptance of a VoIP call within the network.

In addition to monitoring of VoIP and other network assets to update audit results (and take any appropriate remedial action, the appliance may engage in various forms of traffic monitoring. This may include, for example, monitoring VoIP traffic within a network to identify, for example unusual or unexpected traffic patterns (such as might arise from a VoIP-based denial of service attack), unexpected new VoIP connections, or malformed packet headers or other anomalies within VoIP data. By applying signature-based detection of known VoIP security threats, heuristic monitoring for likely threats, and so forth, the appliance may provide continuous monitoring and protection to a VoIP network, or more generally, to a network that supports VoIP traffic. More generally, monitoring of VoIP traffic may employ any suitable security techniques including, for example, intrusion detection techniques, network sniffing, exploit signature detection, heuristic monitoring, and so forth.

Where the monitoring described in step 910 detects a change in network assets and/or a potential threat in network traffic as generally described above, the process 900 may return to step 906 where any new vulnerabilities are identified and the network is further reconfigured to address the changes.

The nature of a response in the monitoring and reconfiguration steps may vary according to the nature of the detected threat. One typical response, particularly to dynamic threats such as suspicious traffic patterns, may be to generate an alert to any suitable individuals. Another response may be to terminate one or more VoIP connections associated with the suspicious traffic.

Various optional features for a VoIP security appliance as described herein are now described in greater detail.

In one aspect, an appliance may use its awareness of network assets and network traffic to enforce Quality of Service, or Quality-of-Service-like constraints on VoIP traffic, such as by allocating use of network resources among various VoIP device nodes.

The system may be self healing capability, that is, if a CVE can be automatically remedied, it will be done through the system by way of integration with traditional patch management and/or configuration management systems through the VOIP-CVE-REMEDY system.

The appliance may be physically embodied in a traditional rack mount appliance. In other embodiments, the appliance may be embodied in a portable and/or very compact computer micro-appliance that can, for example, fit into a pocket or in the palm of a human hand. This micro-appliance may be deployed at a site by simply attaching to a network port, and may operate to find most or all of the VoIP common vulnerabilities and exposures (CVEs) on VoIP network-based assets such as computers, servers and related computer and network equipment and share this data with numerous INFOSEC Countermeasures including but not limited to intelligent VoIP ready firewalls and SmartSwitches to dynamically reconfigure their rules tables and access points including the physical ports of SmartSwitches providing time to repair VoIP vulnerabilities before they are exploited by hackers, viruses or worms.

In one aspect, the appliance may be operated to provide a VoIP vulnerability management and intrusion prevention system that helps to resolve through partial or full automated remediation most or all of the VoIP common vulnerabilities and exposures (CVEs) found on VoIP network-based assets such as VoIP enabled computers, servers and related computer and VoIP network equipment and share this data with the VoIP switching systems, serial connectivity devices, extension and remote access products, technologies, software and hardware. The VoIP switching and connectivity solutions provide IT (information technology) managers with access and control of multiple VoIP servers and network data centers from any location. Analog, digital and serial VoIP switching solutions, as well as extension and remote access products, technologies and software, help in managing multiple VoIP servers and serially controlled devices from a single local or remote console consisting of a administration interface. Switching solutions provide multiple users with the ability to move VoIP data throughout a network from any location that is authorized including through integration with traditional Public Switched Telephone Networks (PSTNs).

In another aspect, the appliance may provide a web-based administrative console to display, e.g., whether in delayed or real-time methodologies, detection of rogue VoIP enabled wired and wireless devices, laptops, mobile equipment and the like, the critical VoIP related CVE information discovered on the network through automated scanning and auditing means.

In another aspect, the appliance may provide a web-based interface to manage and display more detailed asset information such as ownership, serial number, user name, make, model, manufacturer, emergency contact, purchase or lease price and terms as well as any other relevant information that can be attributed to the asset (such as VoIP IP Address, SIP related information, MAC address, operating system, hardware specifications, software specifications, physical location, etc.).

In another aspect, the appliance may provide a web-based interface to connect to a subscription service for access to IT manager related add-ons or plug-ins that will help the IT manager do a better job at managing and protecting said assets in relation to their INFOSEC countermeasures in use, proof of best practices for ISO17799 or similar security and compliance models as well as any other relevant and useful upgrades and additions to the invention.

In another aspect, the appliance may operate to coordinate operation of non-VoIP enabled firewalls, VoIP-ready firewalls, virtual private networks, and SmartSwitches to enable clientless quarantine of network security problems, blocking ports, reporting, logging and database related storage, tracking and backing up of security auditing related and vulnerability assessment information.

In another aspect, the appliance may share authentication and related access control information, protocols and communications with the security services to enable client software to create administrative and user access, privileges and controls.

In another aspect, the appliance may detect and prevent the success of man-in-the-middle and other eavesdropping attacks against VoIP networks by detecting the weaknesses, in advance of an attack, of the VoIP assets which are susceptible to such attack and to dynamically reconfigure the VoIP network and VoIP countermeasures to provide an IT staff the time necessary to remediate the VoIP or related CVE which may be exploited for said attack methodology and to provide remediation instructions which may include one-click fixes such as patches or system reconfigurations to harden the VoIP asset against successful exploit.

It will be appreciated that the above process may be realized in hardware, software, or any combination of these suitable for the three-dimensional imaging techniques described herein. The process may be realized in one or more microprocessors, microcontrollers, embedded microcontrollers, programmable digital signal processors or other programmable device, along with internal and/or external memory. The process may also, or instead, include an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across various devices and/or appliances in a number of ways, or all of the functionality may be integrated into a dedicated, standalone VoIP security appliance. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the inventions disclosed herein are to be understood in the broadest sense allowable by law.

What is claimed is:

1. A method for securing a VoIP system comprising:
auditing a network containing a plurality of assets to identify one or more of the plurality of assets associated with a VoIP system; and
identifying one or more vulnerabilities associated with the one or more of the plurality of assets.

2. The method of claim 1 wherein identifying one or more vulnerabilities includes comparing a dictionary of common vulnerabilities and exploits to the one or more of the plurality of assets.

3. The method of claim 1 further comprising monitoring the network to detect changes in the one or more of the plurality of assets associated with the VoIP system and, in response to a detected change, identifying any additional vulnerabilities.

4. The method of claim 3 wherein the detected change includes an addition of a VoIP phone.

5. The method of claim 4 further comprising reconfiguring the network to secure the network against the additional vulnerabilities associated with the VoIP phone.

6. The method of claim 1 wherein identifying one or more vulnerabilities includes periodically updating a dictionary of common vulnerabilities and exploits.

7. The method of claim 1 further comprising reconfiguring the network to secure the one or more of the plurality of assets against the one or more vulnerabilities.

8. The method of claim 7 wherein reconfiguring the network includes securing an existing hole in a VoIP phone.

9. The method of claim 7 wherein reconfiguring the network includes securing an existing hole in a VoIP gateway.

10. The method of claim 6 wherein reconfiguring the network includes securing an existing hole in a VoIP firewall.

11. A method for securing a VoIP system comprising:
auditing a network to identify a plurality of network assets;
identifying one or more vulnerabilities associated with a VoIP resource intended for use with the network; and
reconfiguring the network to secure the network against the one or more vulnerabilities.

12. The method of claim 11 further comprising connecting the VoIP resource to the network.

13. The method of claim 12 wherein the resource includes an administrative interface to a VoIP network.

14. The method of claim 12 wherein the VoIP resource includes a VoIP phone.

15. The method of claim 12 wherein the VoIP resource includes a VoIP gateway.

16. A method of securing a VoIP system comprising:
auditing a network to identify one or more assets associated with a VoIP system;
monitoring the one or more assets of the VoIP system to identify VoIP traffic; and
analyzing the VoIP traffic for the presence of a security threat.

17. The method of claim 16 further comprising creating an alert when a security threat is detected.

18. The method of claim 16 further comprising terminating a VoIP connection when a security threat is detected.

19. The method of claim 16 wherein analyzing the VoIP traffic includes identifying at least one of a malformed VoIP packet, an unexpected traffic pattern, and an unexpected VoIP session.

20. The method of claim 16 wherein analyzing the VoIP traffic includes at least one of intrusion detection, network sniffing, exploit signature detection, and heuristic monitoring.

21. The method of claim 16 further comprising enforcing at least one Quality of Service constraint on VoIP traffic.
